(19) United States
(12) Patent Application Publication
(10) Pub. No.: US 2012/0131294 A1
(43) Pub. Date: May 24, 2012

(54) PORTABLE DEVICE AND BACKUP METHOD THEREOF

(75) Inventors: Johnny Chen, Santa Ana, CA (US); Wei-Cheng Wang, Santa Ana, CA (US); Hong-Yi Huang, Santa Ana, CA (US)

(73) Assignee: I O INTERCONNECT, LTD., Santa Ana, CA (US)

(21) Appl. No.: 13/053,218

(22) Filed: Mar. 22, 2011

Related U.S. Application Data
(60) Provisional application No. 61/416,281, filed on Nov. 22, 2010.

(51) Int. Cl. G06F 12/16

(52) U.S. Cl. 711/162; 711/E12.103

(57) ABSTRACT

Another embodiment of the invention provides a data saving system including a portable device having a first data, a third party and a storage management server. The storage management server connects at least one backup device, wherein when the portable device wants to save the first data, the portable device transmits the first data and a save command to the third party, the storage management server monitors the third party to determine whether there is data designated to the storage management server, and if yes, the storage management server acquires and transmits the first data to the backup device.

### CROSS REFERENCE TO RELATED APPLICATIONS

This application claims the benefit of U.S. Provisional Application No. 61/416,281, filed Nov. 22, 2010, the entirety of which is incorporated by reference herein.

### BACKGROUND OF THE INVENTION

1. Field of the Invention

The present invention relates to a data saving method, and more particularly to a data saving method for a portable device via a third party.

2. Description of the Related Art

With the growth of the usage of the portable device, a problem has been raised: backing up data of the portable device. One solution is to connect the portable device to a computer or data storage device and store data therein. However, this solution is not convenient for a user. Another solution is directly connecting the portable device to a backup device via a specific communication interface, such as an internet interface.

### BRIEF SUMMARY OF THE INVENTION

An embodiment of the invention provides a portable device that save a first data at a backup device via a third party. The portable device comprises a storage device storing the first data to be saved; and a processor to execute a client-side program to store the first data. The client-side program comprising the steps of: transmitting the first data to the third party; transmitting a saving command to the third party; monitoring the third party by a server to check whether there is data designated to the server; acquiring and transmitting the first data, by the server, to the backup device; transmitting a saving result designated to the portable device, by the server, to the third party; and acquiring the saving result by the portable device.

Another embodiment of the invention provides a saving method for a portable device. The method comprises transmitting a first data from the portable device to a third party; transmitting a saving command generated by the portable device to the third party; monitoring the third party, by a server, to check whether there is data designated to the server for saving; acquiring and transmitting the first data, by the server, to a backup device; saving the first data by the backup device; transmitting a saving result designated to the portable device, by the server, to the third party; acquiring the saving result by the portable device.

Another embodiment of the invention provides a data storage system comprising a portable device having a first data to be saved, a third party and a storage management server. The storage management server connects at least one backup device, wherein when the portable device wants to save the first data, the portable device transmits the first data and a save command to the third party, the storage management server monitors the third party to determine whether there is data designated to the storage management server, and if yes, the storage management server acquires and transmits the first data to the backup device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a data saving mechanism with a third party according to one embodiment of the invention.

FIG. 2 is a schematic diagram of a data saving mechanism with a third party according to another embodiment of the invention.

FIG. 3 is a saving procedure according to one embodiment of the invention.

FIG. 4 is a saving procedure according to another embodiment of the invention.

FIG. 5 is a schematic diagram of a data saving mechanism with a third party according to another embodiment of the invention.

FIG. 6 is a schematic diagram of a data saving mechanism with a third party according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

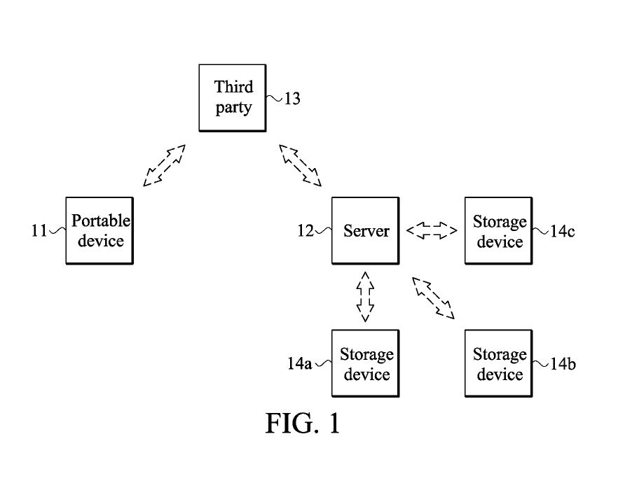

FIG. 1 is a schematic diagram of a data saving mechanism with a third party according to one embodiment of the invention. The server 12 connects to at least one storage device, such as storage device 14a, 14b or 14c. The server 12 communicates with the storage devices via a cable, a USB cable, or a wireless interface. The wireless interface may be a WiFi interface, a Bluetooth interface, an IrDA interface, a CDMA interface or other similar interface. In the present innovation, the portable device 11 does not directly communicate with the server 12. All the data, command, request or other similar exchanged terms between the portable device 11 and the server 12 must be transferred by the third party 13.

When the Portable device 11 wants to store data, the portable device 11 first transmits the first data to the third party 13, and then transmits a command to the third party 13. In another embodiment, both the first data and the command may be transmitted simultaneously to the third party 13. The server 12 monitors the third party 13 to see whether there is data designated to the server 12 or the storage device 14a, 14b or 14c. The user using the portable device 11 can know which storage devices are available by a program embedded in the portable device 11. The first data contains a label indicating the destination storage device. The label may comprise a first unique identification of the storage device. The label may also comprise a second unique identification of the server 12. The storage device 14a, 14b or 14c monitors the label of the data stored in the third party 13 and analyses the first unique identification and the second unique identification thereof to determine whether there is data designated to the storage device 14a, 14b or 14c. The server 12 monitors the third party 13 continuously or periodically to determine whether there is data designated to the server 12. If yes, the server 12 acquires the first data and transmits to the target storage device. After the server 12 acquires the first data in the third party, the server 12 deletes the first data in the third party for security concern.

The first data transmitted by the portable device 11 further comprises a first security information, and before the server 12 stores the first data to the designated storage device, the server 12 first confirms whether the selected storage device is the designated storage device according to the first security information and a second security information of the selected storage device. Only when the second security information matches the first security information, then, will the data be stored in the selected storage device. The first and second security information may be implemented as a private key and a public key.

When the target storage device finishes saving the data, the target storage device transmits the saving result to the server 12 and the server 12 uploads the saving result designated to the portable device 11 to the third party 13. It is noted that the saving result may also contain a label corresponding to the portable device 11 and the label may comprise a third unique identification of the portable device 11.

The portable device 11 monitors the third party 13 continuously or periodically to determine whether there is a saving result designated to the portable device 11. If yes, the portable device 11 acquires the saving result. It is noted that the portable device 11 cannot access the data stored at the target storage device anymore after data the data saving process is completed. The stored data in the storage device is accessed in another access mechanism. For example, a user uses another personal computer to access the stored data via internet or intranet. In the present innovation, the third party 13 exchanges information or data between the portable device 11 and the server 12 only, and the third party 13 does not voluntarily transmit data to the server 12 or the portable device 11. In one example, the third party 13 is merely a storage medium and is capable of being accessed by both the server 12 and the portable device 11. In other words, when the portable device 11 accesses the third party 13, the control of the third party 13 is transferred to the portable device 11, and when the server 12 accesses the third party 13, the control of the third party 13 is transferred to the server 12.

The third party 13 may contain a security mechanism to verify the server 12 and the portable device 11, and after the verification procedure has passed verification, the server 12 and the portable device 11 are authorized to access the third party 13.

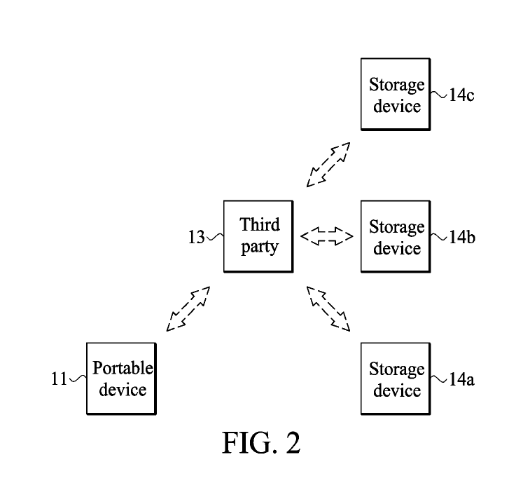

FIG. 2 is a schematic diagram of a data saving mechanism with a third party according to another embodiment of the invention. In FIG. 2, the storage devices 14a, 14b and 14c directly access the third party 13 without the server 12 in FIG. 1.

When the Portable device 11 wants to store data, the portable device 11 first transforms the first data into a second data with an XML format or creates an XML file containing the first data. The portable device 11 then transmits the second data and a command to the third party 13. The storage device 14a, 14b or 14c monitors the third party 13 to see whether there is data designated to the storage device 14a, 14b or 14c. The user using the portable device 11 can know which storage device is available by an application program embedded in the portable device 11. The second data contains a label indicating the destination storage device. The storage devices 14a, 14b and 14c monitor the third party 13 continuously or periodically to determine whether there is data designated to the storage devices 14a, 14b or 14c. If the second data is designated to the storage devices 14a, the storage device 14a acquires and stores the second data. After saving, the storage device 14a transmits a saving result to the third party 13.

The portable device 11 monitors the third party 13 continuously or periodically to determine whether there is a saving result designated to the portable device 11. If yes, the portable device 11 acquires the saving result. It is noted that the portable device 11 cannot access the data stored at the target storage device anymore after the data saving process is completed. The stored data in the storage device is accessed by another access mechanism. In the present innovation, the third party 13 merely exchanges information or data between the portable device 11 and the storage device 14a, 14b or 14c, and the third party 13 cannot voluntarily transmit data to the storage device 14a, 14b or 14c or the portable device 11. In one example, the third party 13 is merely a storage medium and is accessed by the entire storage device 14a, 14b, 14c and the portable device 11. The third party 13 may contain a security mechanism to verify the storage device 14a, 14b, 14c and the portable device 11. After the verification procedure has passed verification, the storage devices 14a, 14b, 14c and the portable device 11 are authorized to access the third party 13

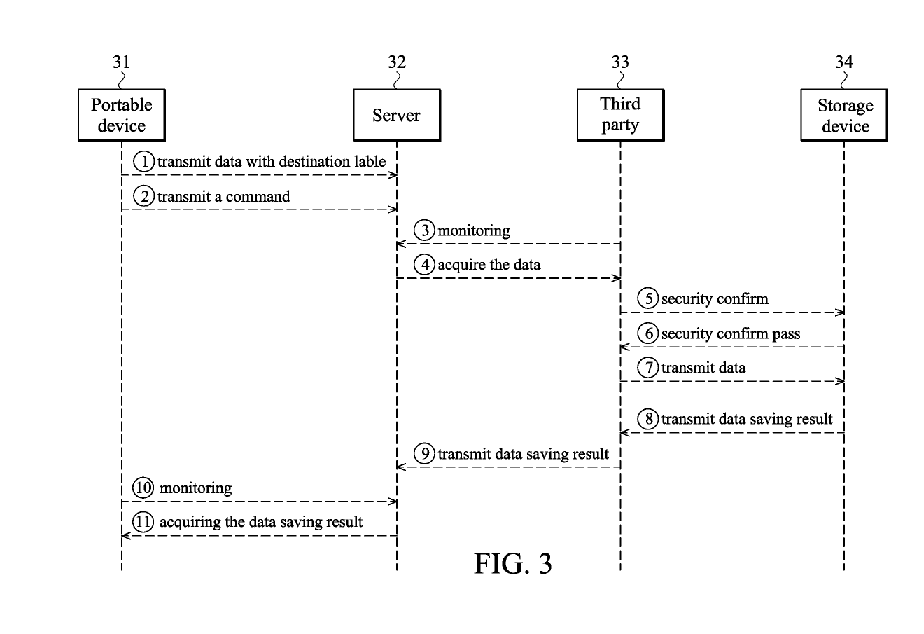

FIG. 3 is a data storing procedure according to one embodiment of the invention. The following steps explain the operation of the data saving procedure.

Step 1: The portable device 31 first transmits the first data with a destination label corresponding to the target device to the third party 32.

Step 2: The portable device 31 transmits a command to the third party 33.

Step 3: The server 32 monitors the third party 33 to see whether there is data designated to the server 32 or the storage device 34.

Step 4: The server 32 acquires first.

Step 5: The server 32 confirms and determines whether the storage device 34 is the target device.

Step 6: The storage device 34 passes the confirmation procedure.

Step 7: The server 32 transmits the first data to the storage device 34.

Step 8: The storage device 34 transmits the saving result to the server 32 after saving.

Step 9: The server 32 uploads the saving result designated to the portable device 31 to the third party 33.

Step 10: The portable device 31 monitors the third party 33 continuously or periodically to determine whether there is a saving result designated to the portable device 31.

Step 11: The portable device 31 acquires the saving result.

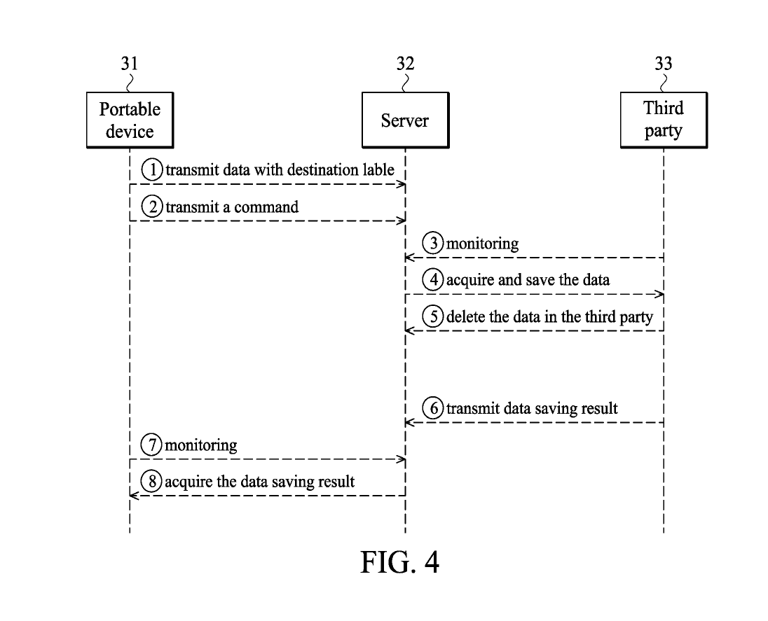

FIG. 4 is a data storing procedure according to another embodiment of the invention. The following steps explain the operation of the data saving procedure.

Step 1: The portable device 31 first transmits the first data with target device information to the third party 32.

Step 2: The portable device 31 transmits a command to the third party 33.

Step 3: The storage device 32 monitors the third party 33 to see whether there is data designated to the storage device 32.

Step 4: The storage device 32 acquires and saves the data-under-saving.

Step 5: The storage device 32 deletes the data-under-saving in the third party 33.

Step 6: The storage device 32 uploads the saving result designated to the portable device 31 to the third party 33.

Step 7: The portable device 31 monitors the third party 33 continuously or periodically to determine whether there is a saving result designated to the portable device 31.

Step 8: The portable device 31 acquires the saving result.

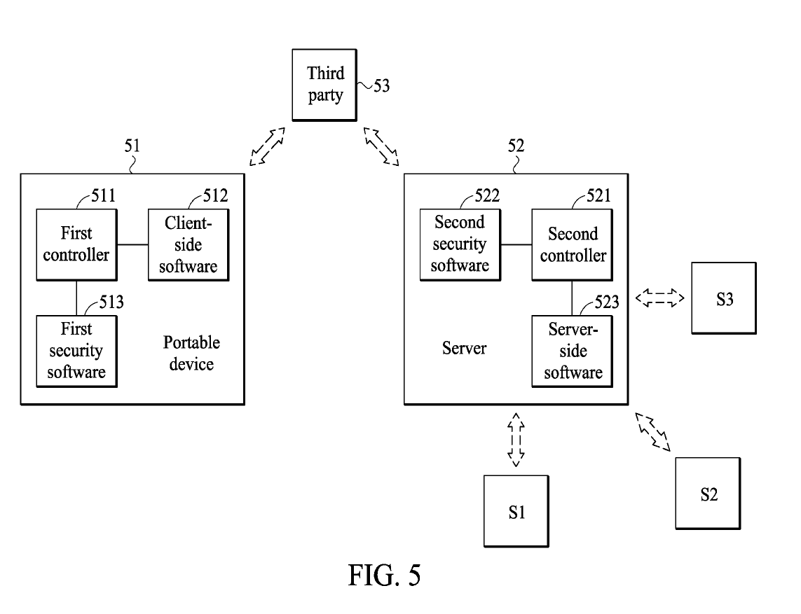

FIG. 5 is a schematic diagram of a data saving mechanism with a third party according to another embodiment of the invention. The portable device 51 comprises a first controller 511, a first security software 513 and client-side software 512. The server 52 comprises a second controller 521, server-side software 523 and second security software 522. The client-side software 512 and the server-side software 523 first execute a security verification procedure with the third party 53 to get the access right of the third party 53. In the present innovation, the third party 53 plays a role for exchanging information or data between the portable device 51 and the server 52 only, and the third party 53 does not voluntarily transmit data to the server 52 or the portable device 51. Furthermore, the portable device 51 does not directly communicate with the server 52. All the data, command, request or other similar exchanged between the portable device 51 and the server 52 must be transferred by the third party 53.

When the portable device 51 wants to store a first data, the first controller 511 executes the client-side software 512 to transmit the first data to the third party 53, and then transmits a command to the third party 53. The first data contains a label indicating the destination storage device and security information generated by the security software 522. The label may comprise a first unique identification of the storage device S1, S2 or S3. The label may also comprise a second unique identification of the server 52.

The server-side software 523 executed by the second controller 521 monitors the third party 53 to see whether there is data designated to the server 52 or the storage device S1, S2 or S3. The user using the portable device 51 can know which storage device are available by the client-side software 512 embedded in the portable device 51. The server-side software 523 monitors the third party 53 continuously or periodically to determine whether there is data designated to the server 52. If yes, the second controller 521 acquires the first data. Before transmitting the first data to the target storage, the security verification procedure 522 verifies a second security information of the target storage device with the first security information. After passing verification, the server 92 transmits data to be saved to the target storage

After the target storage device finishes saving the first data, the target storage device transmits the saving result to the server 52 and the second controller 521 uploads the saving result designated to the portable device 51 to the third party 53 by the server-side software 522. It is noted that the saving result may also contain a label indicating the portable device 51 and the label may comprise a third unique identification of the portable device 51.

The client-side software 512 monitors the third party 13 continuously or periodically to determine whether there is a saving result designated to the portable device 51. If yes, the first controller 511 acquires the saving result by the client-side software 512. In the present innovation, the third party 53 exchanges information or data between the portable device 51 and the server 52 only, and the third party 53 does not voluntarily transmit data to the server 52 or the portable device 51. In one example, the third party 53 is merely a storage medium and is capable of being accessed by both the server 52 and the portable device 51.

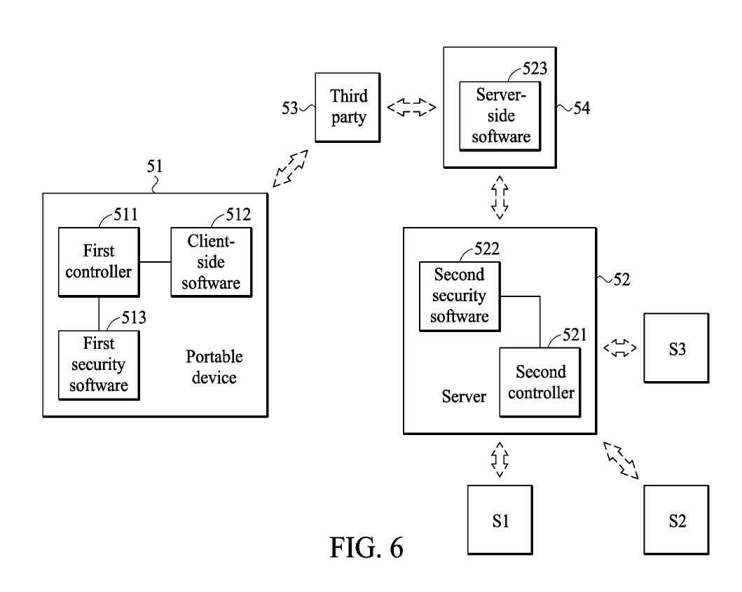

FIG. 6 is a schematic diagram of a data saving mechanism with a third party according to another embodiment of the invention. The most different feature of this embodiment is that the server-side software 523 is embedded in a dongle 54. The dongle 54 connects to the server 52, a hard disk of the server 52 or router of an internet network, stores the server-side software 523 and authorization information.

The portable device 51 comprises a first controller 511, a first security software 513 and client-side software 512. The server 52 comprises a second controller 521 and second security software 522. The client-side software 102 and the server-side software 104 first execute a security verification procedure with the third part 13 to get the access right of the third party 13. In the present innovation, the third party 13 exchanges information or data between the portable device 11 and the server 12 only, and the third party 13 does not voluntarily transmit data to the server 12 or the portable device 11. Furthermore, the portable device 11 does not directly communicate with the server 12. All the data, commands, requests or other similar information exchanged between the portable device 11 and the server 12 must be transferred by the third party 13.

When the portable device 51 wants to store data, the first controller 511 executes the client-side software 512 to transmit the first data to the third party 53, and then transmits a command to the third party 53. The first data contains a label indicating the destination storage device and security information generated by the security software 522. The label may comprise a first unique identification of the storage device S1, S2 or S3. The label may also comprise a second unique identification of the server 52.

The server-side software 523 monitors the third party 53 to see whether there is data designated to the server 52 or the storage device S1, S2 or S3. The user using the portable device 51 can know which storage device are available by the client-side software 512 embedded in the portable device 51. The server-side software 523 monitors the third party 53 continuously or periodically to determine whether there is data designated to the server 52. If yes, the server-side software 523 acquires and passes the first data to the server 52. When receiving the first data, the second controller 103 transmits the data-under-saving to the target storage device.

After the target storage device finishes saving the first data, the target storage device transmits the saving result to the server 52 and the second controller 521 uploads the saving result designated to the portable device 51 to the third party 53 with the cooperation of the server-side software 523. It is noted that the saving result may also contains a label indicating the portable device 51 and the label may comprise a third unique identification of the portable device 51. The client-side software 512 monitors the third party 53 continuously or periodically to determine whether there is a saving result designated to the portable device 51. If yes, the first controller 511 acquires the saving result by the client-side software 512. In the present innovation, the third party 53 exchanges information or data between the portable device 51 and the server 52 only, and the third party 53 does not voluntarily transmit data to the server 52 or the portable device 51. In one example, the third party 53 is merely a storage medium and is capable of being accessed by both the server 52 and the portable device 51.

The first data transmitted by the portable device 51 comprises a first security information generated by the first security software 513, and before the server 52 stores the first data to the designated storage device, the second controller executes the second security software 513 to confirm whether the selected storage device is the designated storage device according to the first security information and a second security information of the selected storage device. Only when the second security information matches the first security information, then, will the data be stored in the selected storage device. The first and second security information may be implemented as a private key and a public key.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable device to save a first data at a backup device via a third party, comprising:
a storage device storing the first data; and
a processor to execute a client-side program to store the first data, wherein the client-side program comprising steps:
transmitting the first data to the third party;
transmitting a saving command to the third party;
monitoring the third party by a server to check whether there is data designated to the server;
acquiring and transmitting the first data, by the server, to the backup device;
transmitting a saving result designated to the portable device, by the server, to the third party; and
acquiring the saving result by the portable device.

2. The device as claimed in claim 1, wherein the first data comprises a destination label containing identification information of the server and/or the backup device.

3. The device as claimed in claim 1, wherein the client-side program is stored in a dongle connected to the portable device.

4. The device as claimed in claim 1, wherein the first data is first transformed into a first data with an XML format and then the first data transmitted to the third party

5. The device as claimed in claim 1, wherein the third party is merely a storage medium for providing data to the portable device and the server, and cannot actively transmit data to the portable device or the server.

6. The device as claimed in claim 1, wherein the portable device communicates with the third party via internet or wireless network.

7. A saving method for a portable device, comprising:
transmitting a first data from the portable device to a third party;
transmitting a saving command generated by the portable device to the third party;
monitoring the third party, by a server, to check whether there is data designated to the server for saving;
acquiring and transmitting the first data, by the server, to a backup device;
saving the first data by the backup device;
transmitting a saving result designated to the portable device, by the server, to the third party; and
acquiring the saving result by the portable device.

8. The method as claimed in claim 7, wherein the method is executed by the portable device.

9. The method as claimed in claim 7, wherein the method is executed by an application program.

10. The method as claimed 9, wherein the application program is stored in a dongle.

11. The method as claimed in claim 10, wherein the dongle may be connected to the server, a router or a hard disk.

12. The method as claimed in claim 7, wherein the first data is first transformed into a first data with an XML format and then the first data is transmitted to the third party.

13. The method as claimed in claim 7, wherein the third party is merely a storage medium for provides data to the portable device and the server, and cannot actively transmit data to the portable device or the server.

14. The method as claimed in claim 7, wherein the portable device communicates with the third party via internet or wireless network.

15. A data saving system comprising:
a portable device having a first data;
a third party; and
a storage management server connecting at least one backup device, wherein when the portable device wants to save the first data, the portable device transmits the first data and a save command to the third party, the storage management server monitors the third party to determine whether there is data designated to the storage management server, and if yes, the storage management server acquires and transmits the first data to a backup device for saving.

16. The system as claimed in claim 15, wherein the third party is a storage medium for providing data to the portable device and the storage management server, and cannot actively transmit data to the portable device or the storage management server.

17. The system as claimed in claim 15, wherein the portable device further comprises a client-side program to transmit the first data and a save command to the third party, monitor the third party to determine whether there is a saving result designated to the portable device, and if yes, the client-side program acquire the saving result.

18. The system as claimed in claim 15, wherein after the first data is saved, the backup device transmits a saving result to the storage management server and the storage management server uploads the saving result to the third party.

19. The system as claimed in claim 18, wherein the storage management server modifies the saving result by adding a label corresponding to portable device to the saving result.

20. The system as claimed in claim 15, further comprising:
a server-side program to monitor the third party to determine whether there is data designated to the storage management server, and if yes, the storage management server acquire and transmit the first data to the backup device.

21. The system as claimed in claim 20, wherein the application program is stored in a dongle.

22. The method as claimed in claim 21, wherein the dongle may be connected to the storage management server, a router or a hard disk.

23. The system as claimed in claim 15, wherein the first data is first transformed into a second data with an XML format and then the second data is transmitted to the third party.
